(19) United States
(12) Patent Application Publication
(10) Pub. No.: US 2025/0377252 A1
(43) Pub. Date: Dec. 11, 2025

(54) SENSOR DEVICES AND ASSOCIATED PRODUCTION AND OPERATING METHODS

(71) Applicant: Infineon Technologies AG, Neubiberg (DE)

(72) Inventors: Christoph OSWALD, Riemerling (DE); Joao CUNHA, München (DE); Andreas KIEP, Muenchen (DE)

(21) Appl. No.: 19/301,400

(22) Filed: Aug. 15, 2025

Related U.S. Application Data
(62) Division of application No. 17/937,580, filed on Oct. 3, 2022.

(30) Foreign Application Priority Data
Oct. 6, 2021 (DE) 102021125949.5

(51) Int. Cl. G01L 3/10; B62D 15/02; G01B 7/30; G01D 5/14; G01L 5/22

(52) U.S. Cl. CPC G01L 3/104; B62D 15/0215; G01B 7/30; G01D 5/145; G01L 5/221

(57) ABSTRACT

A sensor device includes a first stator pair, consisting of a first and second ferromagnetic stators and a second stator pair, consisting of the second ferromagnetic stator and a third ferromagnetic stator. The sensor device includes a multipole magnet, rotatable relative to the two stator pairs. A magnetic field is induced as a result of the rotation. The sensor device includes first and second magnetic field sensors configured to output first and second sensor signals, respectively. The sensor device includes a magnetic flux concentrator configured to concentrate the induced magnetic field at the location of the first magnetic field sensor and at the location of the second magnetic field sensor. The magnetic flux concentrator and the two magnetic field sensors are arranged such that an influence of a rotation-independent magnetic stray field on the sensor signals is compensated for upon difference formation or summation applied to the sensor signals.

### RELATED APPLICATIONS

This application is a divisional of U.S. patent application Ser. No. 17/937,580, filed on Oct. 3, 2022, which claims priority to Germany Patent Application No. 102021125949.5, filed on Oct. 6, 2021, the contents of which are incorporated by reference herein in their entirety.

### TECHNICAL FIELD

The present disclosure relates to sensor devices. Furthermore, the present disclosure relates to methods for operating and for producing sensor devices.

### BACKGROUND

Sensor devices can be used in a large number of technical applications. By way of example, EPS (Electronic Power Steering) systems may use torque sensors. Magnetic stray fields may occur in certain environments and may undesirably influence and corrupt the measurements of the sensor devices. Manufacturers and developers of sensor devices constantly endeavour to improve their products and associated methods. In particular, it may be desirable to provide sensor devices and also associated operating and production methods which work reliably and accurately despite the occurrence of magnetic stray fields.

### SUMMARY

Various aspects relate to a sensor device. The sensor device includes a first stator pair, comprising a first ferromagnetic stator and a second ferromagnetic stator. The sensor device furthermore includes a second stator pair, comprising the second ferromagnetic stator and a third ferromagnetic stator. The sensor device furthermore includes a multipole magnet, which is rotatable relative to the two stator pairs, wherein a magnetic field is induced as a result of the rotation of the multipole magnet relative to the stator pairs. The sensor device furthermore includes a first magnetic field sensor configured to output a first sensor signal. The sensor device furthermore includes a second magnetic field sensor configured to output a second sensor signal. The sensor device furthermore includes a magnetic flux concentrator configured to concentrate the induced magnetic field at the location of the first magnetic field sensor and at the location of the second magnetic field sensor. The magnetic flux concentrator and the two magnetic field sensors are arranged in such a way that an influence of a rotation-independent magnetic stray field on the two sensor signals is compensated for upon difference formation or summation applied to the two sensor signals.

Various aspects relate to a sensor device. The sensor device includes a first stator pair, comprising a first ferromagnetic stator and a second ferromagnetic stator. The sensor device furthermore includes a second stator pair, comprising the second ferromagnetic stator and a third ferromagnetic stator. The sensor device furthermore includes a multipole magnet, which is rotatable relative to the two stator pairs, wherein a magnetic field is induced as a result of the rotation of the multipole magnet relative to the stator pairs. The sensor device furthermore includes a magnetic field sensor configured to output a sensor signal. The sensor device furthermore includes a magnetic flux concentrator configured to concentrate the induced magnetic field at the location of the magnetic field sensor. Upon rotation of the multipole magnet relative to the stator pairs, a first magnetic circuit is formed by the magnetic flux concentrator and the first stator pair and a second magnetic circuit is formed by the magnetic flux concentrator and the second stator pair. The magnetic flux concentrator and the magnetic field sensor are arranged in such a way that an influence of a rotation-independent magnetic stray field on the sensor signal is compensated for upon coupling of the two magnetic circuits.

Various aspects relate to a method. The method includes rotating a multipole magnet relative to a first stator pair and a second stator pair, wherein a magnetic field is induced. The method furthermore includes concentrating the induced magnetic field at the location of a first magnetic field sensor and at the location of a second magnetic field sensor using a magnetic flux concentrator. The method furthermore includes outputting a first sensor signal using the first magnetic field sensor and a second sensor signal using the second magnetic field sensor. The magnetic flux concentrator and the two magnetic field sensors are arranged in such a way that an influence of a rotation-independent magnetic stray field on the two sensor signals is compensated for upon difference formation or summation applied to the two sensor signals.

Various aspects relate to a method for producing a sensor device. The method includes providing a first stator pair and a second stator pair. The method furthermore includes providing a multipole magnet, which is rotatable relative to the two stator pairs, wherein a magnetic field is induced as a result of the rotation of the multipole magnet relative to the stator pairs. The method furthermore includes providing a first magnetic field sensor configured to output a first sensor signal. The method furthermore includes providing a second magnetic field sensor configured to output a second sensor signal. The method furthermore includes providing a magnetic flux concentrator configured to concentrate the induced magnetic field at the location of the first magnetic field sensor and at the location of the second magnetic field sensor. The magnetic flux concentrator and the two magnetic field sensors are arranged in such a way that an influence of a rotation-independent magnetic stray field on the two sensor signals is compensated for upon difference formation or summation applied to the two sensor signals.

### BRIEF DESCRIPTION OF THE DRAWINGS

Sensor devices and also associated production and operating methods in accordance with the disclosure are explained in greater detail below with reference to drawings. Identical reference signs may denote identical components.

FIGS. 1A-1D illustrate the construction of a sensor device 100.

FIG. 2 shows a perspective view of a sensor device 200.

FIG. 3 illustrates a shift in an output signal of a sensor device that is caused by a magnetic stray field.

FIGS. 4A-4E illustrate different views of a sensor device 400 in accordance with the disclosure.

FIG. 5 schematically illustrates magnetic circuits formed in the sensor device 400.

FIG. 6 illustrates output signals of the sensor device 400.

FIG. 7 schematically illustrates magnetic circuits formed in the sensor device 400 under the influence of a magnetic stray field.

FIG. 8 illustrates a shift in output signals of the sensor device 400 that is caused by a magnetic stray field.

FIG. 9 illustrates errors of a magnetic field measurement that are caused by magnetic stray fields.

FIG. 10 illustrates errors of a rotation angle measurement that are caused by magnetic stray fields.

FIGS. 11A-11B illustrate different views of a sensor device 1100 in accordance with the disclosure.

FIGS. 12A-12F illustrate different views of a sensor device 1200 in accordance with the disclosure.

FIG. 13 schematically illustrates magnetic circuits formed in the sensor device 1200.

FIG. 14 illustrates an output signal of the sensor device 1200.

FIG. 15 schematically illustrates magnetic circuits formed in the sensor device 1200 under the influence of a magnetic stray field.

FIG. 16 schematically illustrates magnetic circuits formed in the sensor device 1200 and associated magnetic fluxes under the influence of a magnetic stray field.

FIG. 17 illustrates an output signal of the sensor device 1200 under the influence of a magnetic stray field.

FIG. 18 illustrates a perspective view of a sensor device 1800 in accordance with the disclosure.

FIG. 19 schematically illustrates magnetic circuits formed in the sensor device 1800.

FIG. 20 illustrates output signals of the sensor device 1800 under the influence of a magnetic stray field.

FIG. 21 shows a flow diagram of a method for operating a sensor device in accordance with the disclosure.

FIG. 22 shows a flow diagram of a method for producing a sensor device in accordance with the disclosure.

### DETAILED DESCRIPTION

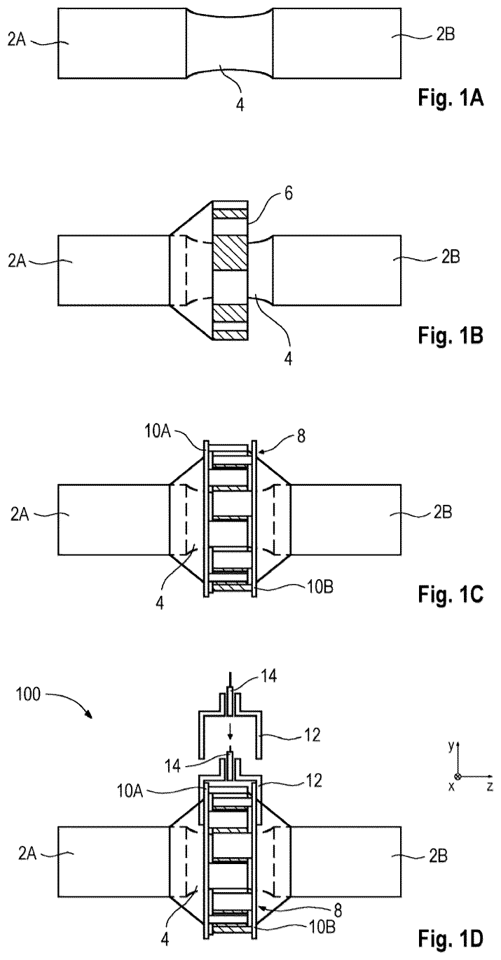

FIGS. 1A to 1D illustrate the construction and the components of a sensor device 100 such as is shown in FIG. 1D. FIG. 1A shows a first rotary shaft 2A and a second rotary shaft 2B, which are connected to one another via a torsion bar 4. As described further below, a torque sensor can be situated at the torsion bar 4 and can be configured to measure a rotation angle between the first rotary shaft 2A and the second rotary shaft 2B. In one example, the rotary shafts 2A and 2B can be part of a steering column or can be mechanically coupled to such a steering column. In this case, the first rotary shaft 2A can be an input shaft running from a steering wheel to the torque sensor, and the second rotary shaft 2B can be an output shaft running from the torque sensor to a steering shaft coupler.

The torque sensor situated at the torsion bar 4 can have a rotor and a stator. FIG. 1B shows a rotor in the form of a multipole magnet 6 embodied in a ring-shaped fashion, which multipole magnet can have a multiplicity of alternating magnetic north poles and magnetic south poles. The rotor or the multipole magnet 6 can be secured to the first rotary shaft 2A or be rotationally fixed with respect thereto.

FIG. 1C shows a stator, consisting of a stator pair 8. The stator pair 8 can consist of a first ferromagnetic stator 10A and a second ferromagnetic stator 10B. The stator pair 8 can be secured to the second rotary shaft 2B or be rotationally fixed with respect thereto.

FIG. 1D shows the sensor device 100, which can also have a magnetic flux concentrator 12 and a magnetic field sensor 14 besides the components described previously. The magnetic field sensor 14 can be for example a (in particular contactless) Hall sensor configured to detect a magnetic field and to output an associated measurement signal. In this case, the output signal can be directly proportional to the detected magnetic field. The magnetic flux concentrator 12 can be configured to concentrate a magnetic field at the location of the magnetic field sensor 14. In FIG. 1D, an arrow indicates how the magnetic flux concentrator 12 together with the magnetic field sensor 14 can be arranged around the stator and the rotor from above.

Upon rotation of the first rotary shaft 2A relative to the second rotary shaft 2B, the multipole magnet 6 can be rotated relative to the ferromagnetic stators 10A and 10B. In this case, a rotation of the multipole magnet 6 can be based on a rotation of the steering column or a rotation of a steering wheel. In the example in FIGS. 1A-1D, the axis of rotation of the multipole magnet 6 can run along the z-axis. As a result of a rotation of the multipole magnet 6, a magnetic flux change or a magnetic field can be generated (or induced) and can be detected by the magnetic field sensor 14. In this case, the magnetic flux change can be proportional to the rotation angle. The rotation angle between the first rotary shaft 2A and the second rotary shaft 2B and also a torque applied to the first rotary shaft 2A (generated for example by a driver of a vehicle) can be determined based on the magnetic flux change detected by the magnetic field sensor 14.

The sensor device 100 can be for example part of an EPS system, e.g., of an electrical power-assisted steering system. The EPS system can have an electric motor (not illustrated) for steering assistance of the power-assisted steering system. From the information about the applied torque provided by the magnetic field sensor 14, a control unit (ECU, Electronic Control Unit) (not illustrated) of the EPS system can ascertain required steering assistance of the electrical power-assisted steering system. In order to provide the steering assistance, the electric motor can be driven by way of a 3-phase driver IC, for example. It should be noted that an application of the sensor devices described herein is not restricted to electrical power-assisted steering systems. Rather, the sensor devices described herein can be implemented in any applications for whose operation a determination of an angle of rotation or a torque is intended to be provided.

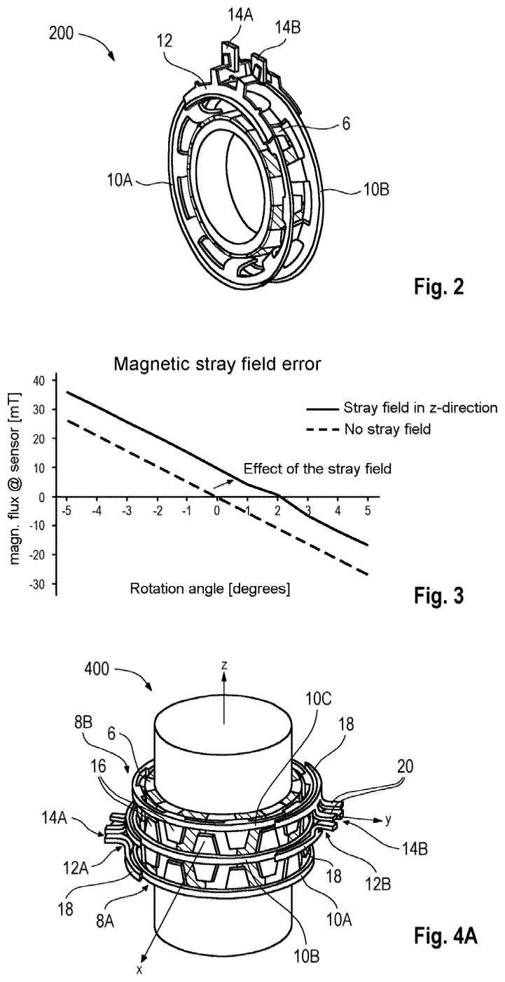

The sensor device 200 in FIG. 2 can be similar to the sensor device 100 in FIGS. 1A-1D and have identical properties. The rotary shafts 2A and 2B and also the torsion bar 4 from FIGS. 1A-1D are not illustrated in FIG. 2, for pictorial reasons. In contrast to FIGS. 1A-1D, the sensor device 200 in FIG. 2 can have two magnetic field sensors 14A and 14B. Use of a second magnetic field sensor makes it possible to provide a redundant second measurement of the magnetic field or a second redundant measurement channel.

FIG. 3 shows output signals of a sensor device. The sensor device can be for example one of the sensor devices 100 and 200 from FIGS. 1A-1D and 2, respectively. In this case, a magnetic field in mT detected by the sensor device is plotted against a rotation angle of a rotor or multipole magnet in degrees. A first, dashed curve shows a signal output by the sensor device in the absence of magnetic stray fields. The first curve has a linear profile and has a detected magnetic field strength of 0 mT at a rotation angle of 0 degrees. A second, continuous curve shows an output signal of the sensor device in the presence of a magnetic stray field in the z-direction, e.g., in the direction of the axis of rotation. The second curve substantially corresponds to a first curve shifted upwards. The second curve has a detected magnetic field strength of approximately 10 mT at a rotation angle of 0 degrees. Comparison of the two curves reveals an undesirable influence of the magnetic stray field on the measurement results of the sensor device. Accordingly, the sensor device cannot provide stray field-robust measurements.

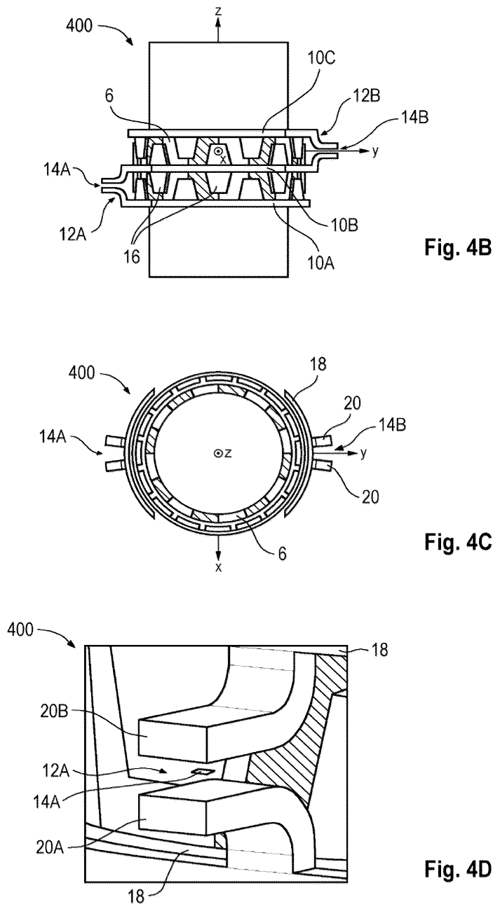

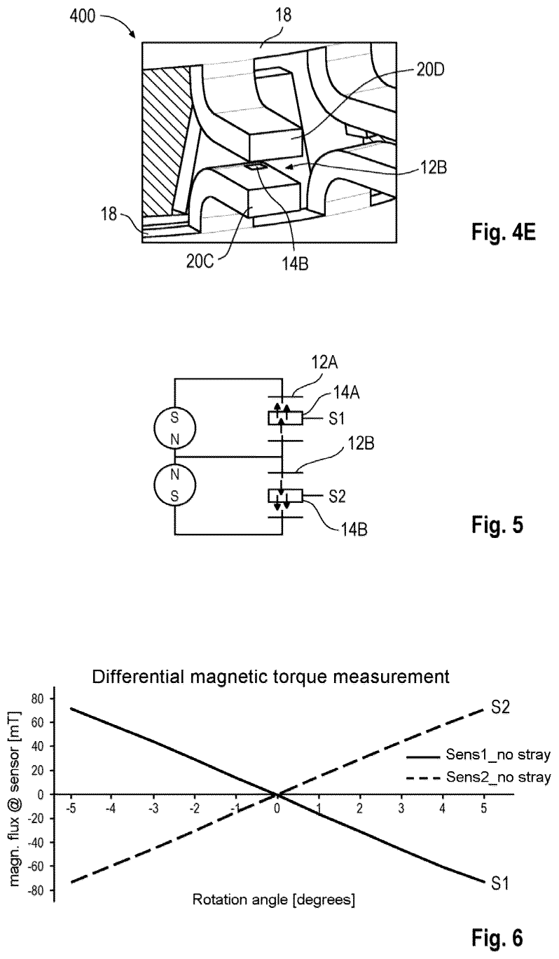

FIGS. 4A-4E show different views of a sensor device 400 in accordance with the disclosure. In this case, FIG. 4A shows a perspective view, FIG. 4B shows a side view and FIG. 4C shows a plan view of the sensor device 400. FIGS. 4D and 4E each show enlarged details of the sensor device 400. The sensor device 400 can be at least partly similar to the sensor devices from preceding figures and have identical properties.

The sensor device 400 can have a first stator pair 8A and a second stator pair 8B. The position of the stator pairs 8A and 8B relative to one another can be fixed. The first stator pair 8A can consist of a first ferromagnetic stator 10A and a second ferromagnetic stator 10B. Analogously, the second stator pair 8B can consist of a third ferromagnetic stator 10B and a fourth ferromagnetic stator 10C. In the example in FIGS. 4A-4E, the third ferromagnetic stator 10B of the second stator pair 8B can correspond to the second ferromagnetic stator 10B of the first stator pair 8A. In other words, the two stator pairs 8A and 8B can share the central stator 10B. A reduced dimensioning of the sensor device 400 in the z-direction can be achieved as a result. In further examples (not shown), the stator pairs 8A and 8B can have stators that are separate from one another. Each of the ferromagnetic stators 10A to 10C can be embodied in a ring-shaped fashion (or in the shape of a rim) and can have a multiplicity of teeth (or blades) 16. In this case, the ferromagnetic stators of each stator pair can be arranged opposite one another in such a way that the teeth 16 of the opposite stators intermesh or interlock.

The sensor device 400 can have a multipole magnet 6. The multipole magnet 6 can be embodied in a ring-shaped fashion (or in the shape of a rim) and can have a multiplicity of alternating magnetic north poles and magnetic south poles. In the example in FIGS. 4A-4E, the multipole magnet 6 can have sixteen alternating magnet poles. In further examples, the number of alternating magnet poles can be chosen to be smaller or larger as desired. Of course, the number of teeth 16 can be coordinated with the number of pole pairs of the multipole magnet 6. The multipole magnet 6 can have a plurality of permanent magnets along its circumference, for example. These magnets can be arranged in such a way that a north pole and a south pole are situated alternately along the outer edge of the multipole magnet 6. The stator pairs 8A, 8B and the multipole magnet 6 can be arranged around rotary shafts or around a torsion bar, as described in associated with FIGS. 1A-1D. In this case, the stator pairs 8A and 8B can be secured to a first rotary shaft, and the multipole magnet 6 to a second rotary shaft. The rotary shafts can be connected to one another via the torsion bar.

The multipole magnet 6 can be rotatable relative to each of the stator pairs 8A and 8B. In the example in FIGS. 4A-4E, the multipole magnet 6 can be rotated about an axis of rotation running in the z-direction. This axis of rotation can correspond to a common axis of symmetry of the first stator pair 8A, of the second stator pair 8B and of the multipole magnet 6. The example illustration in FIGS. 4A-4E show the sensor device 400 in a non-rotated state of the multipole magnet 6, e.g., at a rotation angle of zero degrees. In such a zero position of the multipole magnet 6, each tooth 16 of the stators 10A to 10C can be arranged between a north pole and a south pole of the multipole magnet 6. In some implementations, the stators 10A to 10C can be arranged exactly between a north pole and a south pole of the multipole magnet 6. In other words, each tooth 16 of the stators 10A to 10C can be at an identical distance from a north pole and a south pole of the multipole magnet 6.

The sensor device 400 can have a first magnetic flux concentrator 12A and a second magnetic flux concentrator 12B. In FIGS. 4A-4E, the first magnetic flux concentrator 12A can be arranged on the left outer side of the first stator pair 8A, and the second magnetic flux concentrator 12B can be arranged on the right outer side of the second stator pair 8B. In the example in FIGS. 4A-4E, each of the magnetic flux concentrators 12A and 12B can have two parts, which can be arranged one above the other in the z-direction. Each of these parts can have a circle-arc-shaped first section 18 running along a ferromagnetic stator, and also two radially outwardly projecting second sections 20. Enlarged views of the magnetic flux concentrators 12A and 12B can be seen in FIGS. 4D and 4E, respectively.

The sensor device 400 can have a first magnetic field sensor 14A and a second magnetic field sensor 14B. The magnetic field sensors 14A and 14B are not explicitly illustrated in FIGS. 4A to 4C, rather their positions are merely indicated by arrows. Example exact positions of the magnetic field sensors 14A and 14B are shown in the enlarged views in FIGS. 4D and 4E. Each of the magnetic field sensors 14A and 14B can have at least one sensor element and can be configured to detect a magnetic field at the location of the sensor element. In particular, each of the magnetic field sensors 14A and 14B can be configured to detect an absolute magnetic field strength of a magnetic field. In this case, the respective magnetic field sensor can detect both the absolute value of the detected magnetic field and the sign, e.g. the direction, of the magnetic field. Based on the detected magnetic field, the respective magnetic field sensor can output a signal which can be in particular directly proportional to the detected magnetic field. The sensor elements of the magnetic field sensors 14A and 14B can be Hall sensor elements, in particular. The magnetic field sensors 14A and 14B can be embodied as (in particular contactless) Hall sensors. The magnetic field sensors 14A and 14B can be linear sensors, in particular.

A position of the first magnetic field sensor 14A can be rotated relative to a position of the second magnetic field sensor 14B about the axis of rotation or symmetry. In particular, it is discernible in the plan view in FIG. 4C that, in the example shown there, the magnetic field sensors 14A and 14B can be rotated by an angle of 180 degrees with respect to one another. In further examples, the magnetic field sensors 14A and 14B can be rotated by a different angle with respect to one another.

FIGS. 4D and 4E show more detailed views of the magnetic flux concentrators 12A and 12B, respectively. In FIG. 4D, the first magnetic flux concentrator 12A can have a first section 20A coupled to the first ferromagnetic stator 10A, and a second section 20B coupled to the second ferromagnetic stator 10B. Analogously, in FIG. 4E, the second magnetic flux concentrator 12B can have a third section 20C coupled to the second ferromagnetic stator 10B and a fourth section 20D coupled to the third ferromagnetic stator 10C. Each of the four sections 20A to 20D can point substantially radially outwards and run substantially perpendicular to the axis of rotation of the multipole magnet 6.

In FIG. 4D, the first magnetic field sensor 14A can be arranged between the first section 20A and the second section 20B of the first magnetic flux concentrator 12A. Analogously, in FIG. 4E, the second magnetic field sensor 14B can be arranged between the third section 20C and the fourth section 20D of the second magnetic flux concentrator 12B. The first magnetic flux concentrator 12A can be configured to concentrate a magnetic field at the location of the first magnetic field sensor 14A. Analogously, the second magnetic flux concentrator 12B can be configured to concentrate a magnetic field at the location of the second magnetic field sensor 14B. The first magnetic field sensor 14A and the second magnetic field sensor 14B can each be sensitive in a direction parallel to the axis of rotation of the multipole magnet 6, e.g. sensitive in the z-direction. In particular, the magnetic field sensors 14A and 14B can be sensitive in the same direction. In a further example, the magnetic field sensors 14A and 14B can have sensitivity directions opposite to one another.

On account of the north and south poles arranged in an alternating fashion, a rotation of the multipole magnet 6 can induce a magnetic field. The generated magnetic field can be concentrated at the locations of the magnetic field sensors 14A and 14B by the magnetic flux concentrators 12A and 12B, respectively. The directions of the concentrated magnetic fields can be dependent on the direction of rotation of the multipole magnet 6. In one example, the magnetic field concentrated at the location of the first magnetic field sensor 14A can run in the positive z-direction, and the magnetic field concentrated at the location of the second magnetic field sensor 14B can run in the negative z-direction. The magnetic fields concentrated at the locations of the magnetic field sensors 14A and 14B, respectively, can substantially have an identical absolute value and opposite signs.

FIG. 5 schematically illustrates, in a simplified illustration, magnetic circuits such as can be formed in the sensor device 400 from FIGS. 4A-4E upon rotation of the multipole magnet 6. In an upper first magnetic circuit, the magnetic field concentrated at the location of the first magnetic field sensor 14A is indicated by small arrows pointing upwards. The first magnetic field sensor 14A can detect the magnetic field concentrated at its location and can output a sensor signal S1. Analogously, in a lower second magnetic circuit, the magnetic field concentrated at the location of the second magnetic field sensor 14B is indicated by small arrows pointing downwards. The magnetic fields concentrated at the locations of the magnetic field sensors 14A, 14B can be oriented in opposite directions, in particular. The second magnetic field sensor 14B can detect the magnetic field concentrated at its location and can output a sensor signal S2.

FIG. 6 shows output signals of the sensor device 400 or of the magnetic field sensors 14A, 14B. Referring to FIG. 5, the output signals can be the sensor signals S1 and S2. The magnetic fields in mT detected by the magnetic field sensors 14A and 14B are plotted against a rotation angle of the multipole magnet 6 in degrees. A first, solid curve shows the output signal S1 of the first magnetic field sensor 14A in the absence of magnetic stray fields. A second, dashed curve shows the output signal S2 of the second magnetic field sensor 14B in the absence of magnetic stray fields. The second curve substantially corresponds to an inversion of the first curve. The curves in FIG. 6 show a linear dependence of the signals output by the magnetic field sensors 14A and 14B on the angle of rotation of the multipole magnet 6. Both curves have a substantially linear profile and indicate a detected magnetic field strength of 0 mT at a zero position (e.g. at a rotation angle of 0 degrees) of the multipole magnet 6.

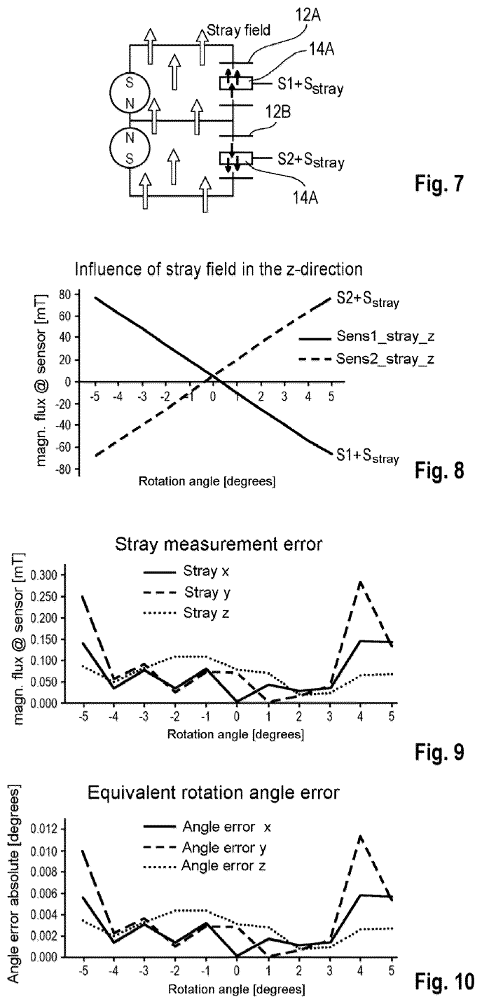

FIG. 7 schematically illustrates, in a simplified illustration, magnetic circuits formed in the sensor device 400 under the influence of a magnetic stray field. The magnetic circuits shown can correspond to the magnetic circuits shown in FIG. 5. In FIG. 7, the magnetic stray field is additionally indicated by arrows pointing upwards. In the example in FIG. 7, the magnetic stray field can run in the z-direction. The magnetic stray field can in particular be independent of the rotation of the multipole magnet 6 relative to the stator pairs 8A, 8B. The magnetic stray field can be superposed on the magnetic fields concentrated at the locations of the magnetic field sensors 14A, 14B. In comparison with FIG. 5, the sensor signals output by the magnetic field sensors 14A, 14B can have a component S_{stray} caused by the stray field. In the example in FIG. 7, the contribution S_{stray} of the stray field is added to each of the sensor signals S1 and S2.

FIG. 8 illustrates output signals of the sensor device 400 or of the magnetic field sensors 14A, 14B contained therein under the influence of a magnetic stray field in the z-direction. In contrast to FIG. 6, the output signals of the two magnetic field sensors 14A and 14B can be shifted upwards on account of the component S_{stray} caused by the magnetic stray field. It is evident from FIG. 8 that the signal shift caused by the magnetic stray field influences both sensor channels in the same way.

Based on the measurements of the magnetic field sensors 14A and 14B, it is possible to determine a difference (or a sum) from the sensor signals output by the magnetic field sensors 14A and 14B. The difference (or sum) can be determined for example by one or both of the magnetic field sensors 14A and 14B or by a further component, such as a control unit, for example. As described below, an influence of magnetic stray fields on the detected difference (or sum) can be compensated for.

From the two signals output by the magnetic field sensors 14A and 14B, it is possible to form a difference signal in accordance with

$${B}_{output} = \frac{{B}_{Sensor 1} - {B}_{Sensor 2}}{2} \qquad ( 1 )$$

In this case, Bₒᵤₜₚᵤₜ is the difference signal that is output, B_{Sensor1} is the signal that is output by the first sensor, and B_{Sensor2} is the signal that is output by the second sensor. In the case of a magnetic stray field, an output signal can arise in accordance with

$${B}_{output} = \frac{( S 1 + {S}_{stray} ) - ( S 2 + {S}_{stray} )}{2} = \frac{S 1 - S 2}{2} \qquad ( 2 )$$

The magnetic flux concentrators 12A, 12B and the magnetic field sensors 14A, 14B can be arranged in such a way that the first output signal S1 and the second output signal S2 are inverted with respect to one another and identical in terms of absolute value if no magnetic stray field is present. In other words, it can hold true that

$$S 2 = - S 1 \qquad ( 3 )$$

This can give rise to the following for the output signal

$${B}_{output} = \frac{S 1 - ( - S 1 )}{2} = \frac{2 S 1}{2} = S 1 \qquad ( 4 )$$

On account of an identical influence of the magnetic stray field on the first sensor signal S1 and on the second sensor signal S2, the components of the magnetic stray field can thus cancel one another out upon difference formation.

In accordance with the above explanations, accordingly, the chosen arrangement of the magnetic flux concentrator 12A, 12B and of the two magnetic field sensors 14A, 14B makes it possible to compensate for an influence of the rotation-independent magnetic stray field on the two sensor signals upon difference formation applied to the two sensor signals. In this context, it should be pointed out that a difference between the two sensor signals need not necessarily be formed in further examples. Compensation of the magnetic stray field can also be achieved by way of summation applied to the two sensor signals, for example if one of the two magnetic field sensors 14A, 14B is turned over and its output signal only changes sign as a result. The terms difference formation and summation may therefore be regarded as interchangeable in the examples described herein.

The sensor device 400 in FIGS. 4A-4E and all further sensor devices in accordance with the disclosure described herein can thus be configured to provide measurements that are independent of magnetic stray fields. In other words, the sensor device 400 can provide stray field-robust measurements. Accordingly, the sensor device 400 in FIGS. 4A-4E and similar sensor devices in accordance with the disclosure need not necessarily have one or more electromagnetic shields for shielding the magnetic field sensors 14A and 14B from magnetic stray fields. In this context, it should also be noted that the magnetic stray fields considered herein can be both homogeneous stray fields and inhomogeneous stray fields. In particular, it can be assumed that on the relevant spatial dimensions considered herein in the case of the magnetic field sensors 14A, 14B, an inhomogeneous stray field can be approximated by a homogeneous stray field.

As is additionally evident from table 1 discussed below, the value calculated using the difference formation under the influence of a magnetic stray field corresponds to the value calculated using the difference formation without a disturbance by a magnetic stray field. Table 1 below shows various output signals of two magnetic field sensors of a sensor device in accordance with the disclosure. By way of example, they can be the output signals of the magnetic field sensors 14A and 14B of the sensor device 400. The first column of table 1 includes values of a difference signal in the absence of a magnetic stray field. The second and third columns of table 1 include values of the signals output by the first magnetic field sensor 14A and the second magnetic field sensor 14B, respectively, in the presence of a magnetic stray field in the z-direction. The fourth column of table 1 includes values of a difference signal in the presence of the magnetic stray field.

TABLE 1

| No stray field, | z-stray | z-stray | z-stray field, |
|---|---|---|---|
| (S1 − S2)/2 | field, S1 | field, S2 | (S1 − S2)/2 |
| 72.23 | 76.92 | −67.72 | 72.32 |
| 58.78 | 63.40 | −54.07 | 58.74 |
| 44.65 | 49.23 | 39.91 | 44.57 |
| 30.08 | 34.85 | −25.59 | 30.19 |
| 15.12 | 19.84 | −10.18 | 15.01 |
| 0.01 | 4.81 | 4.98 | −0.09 |
| −15.11 | −10.29 | 20.07 | −15.18 |
| −30.03 | −25.12 | 34.97 | −30.05 |
| −44.64 | −39.55 | 49.78 | −44.66 |
| −58.79 | −53.82 | 63.63 | −58.72 |
| −72.11 | −66.82 | 77.26 | −72.04 |

Table 1 reveals that the respective values of the difference signal in the first and fourth columns are substantially identical and thus substantially independent of the magnetic stray field. Furthermore, table 1 reveals a substantially linear dependence between the difference signal obtained in accordance with equation (1) and the angle of rotation of the multipole magnet. Referring further to the preceding figures, a rotation angle between a first rotary shaft and a second rotary shaft and/or a torque applied to the first rotary shaft can thus be determined based on the difference formed from the first magnetic field and the second magnetic field.

FIG. 9 illustrates errors of a magnetic field measurement that are caused by magnetic stray fields depending on a direction of the magnetic stray field. In this case, an absolute error of the magnetic fields in mT is plotted against a rotation angle in degrees. A first, continuous curve illustrates an absolute error of the magnetic field in the case of a magnetic stray field in the x-direction. A second, dashed curve illustrates an absolute error of the magnetic field in the case of a magnetic stray field in the y-direction. A third, dotted curve illustrates an absolute error of the magnetic field in the case of a magnetic stray field in the z-direction. The respective magnetic stray field can have a magnetic field strength of approximately 4 kA/m, for example.

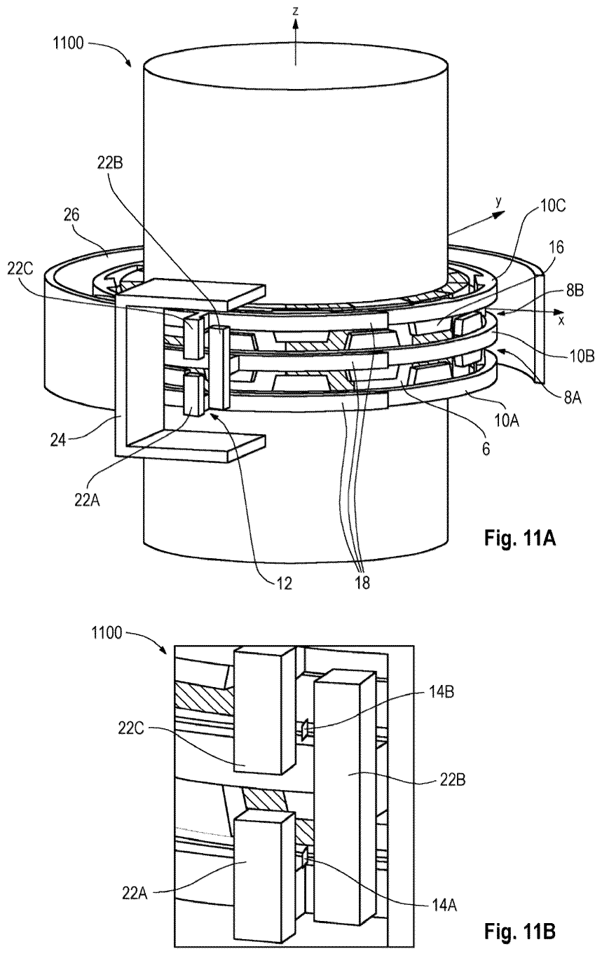

FIG. 10 illustrates errors of a rotation angle measurement that are caused by magnetic stray fields. In this case, an absolute error of the rotation angle in degrees is plotted against the rotation angle in degrees. A first, continuous curve shows an absolute angle error in the case of a magnetic stray field in the x-direction. A second, dashed curve shows an absolute angle error in the case of a magnetic stray field in the y-direction. A third, dotted curve shows an absolute angle error in the case of a magnetic stray field in the z-direction. The respective magnetic stray field can have a magnetic field strength of approximately 4 kA/m, for example.

FIGS. 11A and 11B show different views of a sensor device 1100 in accordance with the disclosure. In this case, FIG. 11A shows a perspective view and FIG. 11B an enlarged detail of the sensor device 1100. The sensor device 1100 can be at least partly similar to the previously described sensor devices and can have similar properties. In contrast to FIGS. 4A-4E, the sensor device 1100 does not have two magnetic flux concentrators 12A, 12B that are spatially separated from one another and are rotated relative to one another about the axis of rotation or symmetry. Instead, the sensor device 1100 can have a more compact magnetic flux concentrator 12 arranged at a single position.

The magnetic flux concentrator 12 can have a first section 22A coupled to the first ferromagnetic stator 10A, a second section 22B coupled to the second ferromagnetic stator 10B, and a third section 22C coupled to the third ferromagnetic stator 10C. Each of the three sections 22A to 22C can run substantially parallel to the axis of rotation of the multipole magnet 6. In the example shown, the sections 22A to 22C can each be embodied in the shape of a beam. The positions of the magnetic field sensors 14A, 14B are discernible in the enlarged view in FIG. 11B. The first magnetic field sensor 14A can be arranged between the first section 22A and the second section 22B of the magnetic flux concentrator 12. Furthermore, the second magnetic field sensor 14B can be arranged between the second section 22B and the third section 22C of the magnetic flux concentrator 12.

The sections 22A to 22C of the magnetic flux concentrator 12 can be configured to concentrate, at the positions of the magnetic field sensors 14A, 14B, the magnetic field generated upon rotation of the multipole magnet 6 relative to the stator pairs 8A, 8B. In this case, the concentrated magnetic fields can extend between the first section 22A and the second section 22B, and respectively between the second section 22B and the third section 22C. In this context, the magnetic flux concentrator 12 can optionally have circle-arc-shaped sections 18 which run along the ferromagnetic stators 10 and which can be configured to guide the magnetic flux generated as a result of the rotation of the multipole magnet 6 to the sections 22A to 22C. The first magnetic field sensor 14A and the second magnetic field sensor 14B can each be arranged such that they are sensitive in a direction substantially perpendicular to the axis of rotation of the multipole magnet 6. The directions of the concentrated magnetic fields and the sensitivity directions of the magnetic field sensors 14A, 14B can thus be aligned substantially parallel to one another.

Analogously to the sensor device 400 in FIGS. 4A-4E, in the sensor device 1100 in FIG. 11A the magnetic flux concentrator 12 and the magnetic field sensors 14A, 14B can be arranged such that an influence of a magnetic stray field independent of the rotation of the multipole magnet 6 on the two sensor signals output by the magnetic field sensors 14A, 14B is compensated for upon difference formation or summation applied to the two sensor signals. The signals output by the magnetic field sensors 14A, 14B can correspond for example to those in FIGS. 6 and 8. The sensor device 1100 can output a difference signal in accordance with equations (1) to (4). For the sake of simplicity, reference is made to preceding passages of text at this juncture.

In comparison with the sensor device 400 in FIGS. 4A-4E, the sensor device 1100 in FIG. 11A can optionally have a first electromagnetic shield 24 and/or a second electromagnetic shield 26. For pictorial reasons, the electromagnetic shields 24 and 26 are only partly shown in FIG. 11A, in order not to conceal an inner part of the sensor device 1100. The first electromagnetic shield 24 can be arranged at least partly around the magnetic flux concentrator 12 and the magnetic field sensors 14A, 14B. In the example in FIGS. 11A-11B, the first electromagnetic shield 24 can e.g. be embodied in a rectangular fashion and be arranged in particular around the sections 22A to 22C of the magnetic flux concentrator 12. The first electromagnetic shield 24 can be configured to shield the magnetic flux concentrator 12 and the magnetic field sensors 14A, 14B from magnetic stray fields. In the example in FIG. 11A, the second electromagnetic shield 26 can e.g. be embodied in a ring-shaped fashion and be arranged around the two stator pairs 8A, 8B and the multipole magnet 6. The use of the two electromagnetic shields 24 and 26 makes it possible to increase the accuracy of a measurement provided by the magnetic field sensors 14A, 14B.

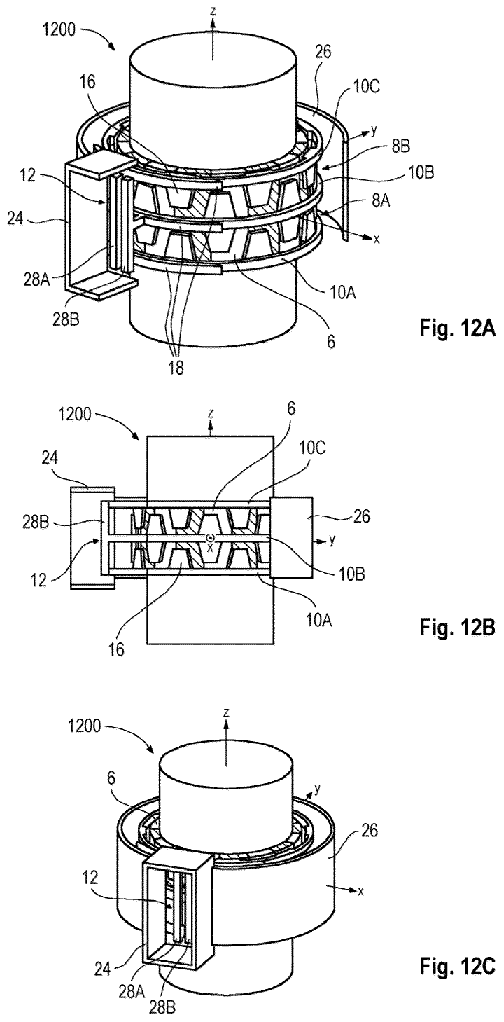

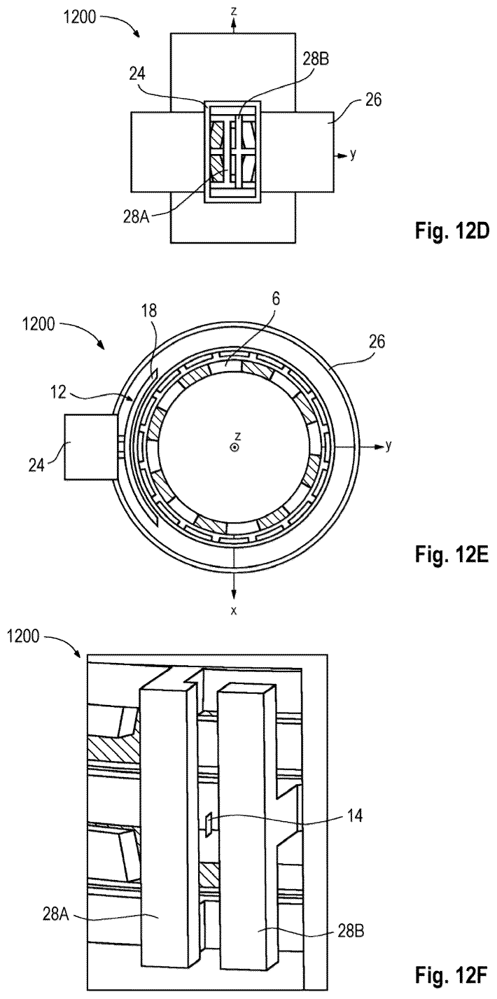

FIGS. 12A-12F show different views of a sensor device 1200 in accordance with the disclosure. The sensor device 1200 can be at least partly similar to the previously described sensor devices and can have similar properties. Analogously to FIGS. 11A-11B, the sensor device 1200 can have a first electromagnetic shield 24 and/or a second electromagnetic shield 26. FIGS. 12A and 12B show a perspective and respectively a lateral view of the sensor device 1200. In this case, for pictorial reasons, the electromagnetic shields 24 and 26 are only partly shown, in order not to conceal an inner part of the sensor device 1200. Furthermore, FIGS. 12C to 12E show a perspective view, a side view and a plan view of the sensor device 1200, the electromagnetic shields 22 and 24 being illustrated completely and in a closed fashion. FIG. 12F shows an enlarged detail of the sensor device 1200.

In terms of construction, the sensor device 1200 can for example be similar to the sensor device 1100 in FIGS. 11A and 11B and have similar components. In comparison with FIGS. 11A-11B, the magnetic flux concentrator 12 of the sensor device 1200 can be embodied differently. In the example in FIGS. 12A-12F, the magnetic flux concentrator 12 can have a first section 28A coupled to the first ferromagnetic stator 10A and the third stator 10C, and also a second section 28A coupled to the second ferromagnetic stator 10B. In the example shown, the sections 28A and 28B can each be embodied in the shape of a beam. Each of the two sections 28A and 28B can run parallel to the axis of rotation of the multipole magnet 6, e.g. in the z-direction. Furthermore, the magnetic flux concentrator 12 can optionally have circle-arc-shaped sections 18 which run along the ferromagnetic stators 10 and which can be configured to guide a magnetic flux generated as a result of rotation of the multipole magnet 6 to the sections 28A and 28B.

In contrast to the previously described sensor devices 400 and 1100 in FIGS. 4A-4E and 11, respectively, the sensor device 1200 in FIGS. 12A-12F can have a single magnetic field sensor 14, which can be arranged between the first section 28A and the second section 28B, and is shown by way of example in the detail view in FIG. 12F. In the example in FIG. 12F, the magnetic field sensor 14 can be arranged in particular centrally between the sections 28A, 28B in relation to the z-direction. In further examples, the magnetic field sensor can be shifted upwards or downwards in the z-direction. A magnetic field concentrated at the location of the magnetic field sensor 14 by the magnetic flux concentrator 12 can run in a direction from the first section 28A to the second section 28B, or vice versa. The magnetic field sensor 14 can be sensitive in particular in the same direction, e.g. in a direction perpendicular to the axis of rotation.

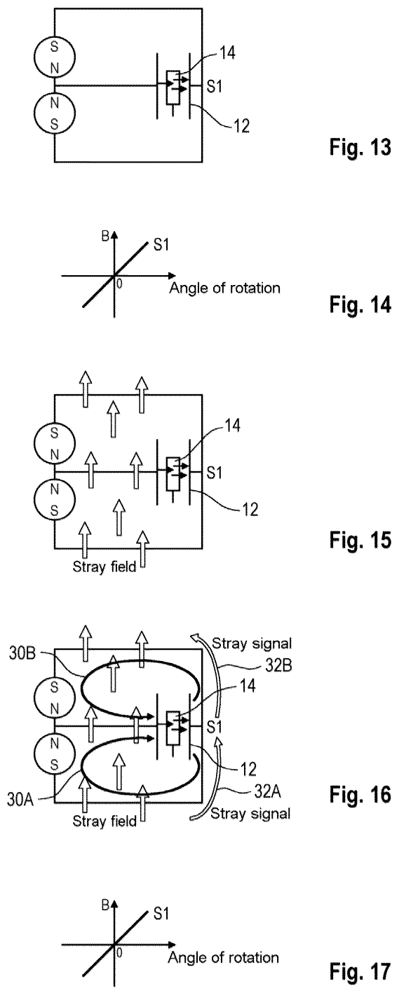

FIG. 13 schematically illustrates, in a simplified illustration, magnetic circuits such as can be formed in the sensor device 1200 from FIGS. 12A-12F. More precisely, upon rotation of the multipole magnet relative to the stator pairs, an upper first magnetic circuit can be formed by the magnetic flux concentrator and the first stator pair and a lower second magnetic circuit can be formed by the magnetic flux concentrator and the second stator pair. The magnetic field concentrated at the location of the magnetic field sensor 14 by the magnetic flux concentrator 12 is indicated by small arrows pointing towards the right. The magnetic field sensor 14 can detect the magnetic field concentrated at its location and can output a sensor signal S1.

FIG. 14 shows an example output signal of the sensor device 1200. In this case, a magnetic field strength measured by the magnetic field sensor 14 is plotted against the angle of rotation. The sensor signal S1 can have a linear profile.

FIG. 15 schematically illustrates, in a simplified illustration, magnetic circuits that are formed in the sensor device 1200 under the influence of a magnetic stray field. The magnetic circuits can correspond to the magnetic circuits shown in FIG. 13. In FIG. 15, the magnetic stray field is additionally indicated by arrows pointing upwards. In the example in FIG. 15, the magnetic stray field can run in the z-direction. The magnetic stray field can be independent in particular of the rotation of the multipole magnet 6 relative to the stator pairs 8A, 8B. The magnetic stray field can be superposed on the magnetic field concentrated at the location of the magnetic field sensor 14.

FIG. 16 illustrates magnetic circuits that occur in the sensor device 1200, as already discussed in association with FIG. 15. A magnetic circuit can be regarded as a closed path of a magnetic flux. A first magnetic flux along a first path 30A in the clockwise direction can be assigned to the lower magnetic circuit, while a second magnetic flux along a second path 30B in the anticlockwise direction can be assigned to the upper magnetic circuit. Each of the two magnetic fluxes can make a contribution to the sensor signal S1 output by the magnetic field sensor 14.

The magnetic stray field can influence each of the two magnetic fluxes. In the example in FIG. 16, an influence of the magnetic stray field on the two magnetic fluxes is indicated by arrows 32A and 32B oriented substantially in the anticlockwise direction. A contribution of the upper magnetic flux along the path 30B to the sensor signal S1 can be amplified by the magnetic stray field (both arrows 30B and 32B run in the same direction). Furthermore, a contribution of the lower magnetic flux along the path 30A to the sensor signal S1 can be reduced by the magnetic stray field (the arrows 30A and 32A run in opposite directions).

In practice or in an overall consideration, the magnetic field sensor 14 will not measure the individual signal contributions of the magnetic circuits separated from one another, rather a measurement will be associated with a coupling of the two magnetic circuits. The measurement can thus involve adding up the error-increased signal contribution (cf. path 30B) together with the error-reduced signal contribution (cf. path 30A), thereby making it possible to compensate for the magnetic stray field in the sensor signal S1. In other words, the magnetic stray field can be imposed oppositely on the signal contributions of the two (opposite) magnetic fluxes. This opposite imposing of the magnetic stray field makes it possible to compensate for the contribution of the magnetic stray field in the sensor signal S1.

The compensation of the influence of the magnetic stray field on the sensor signal S1 upon coupling of the two magnetic circuits can be provided in the sensor device 1200 in particular by way of the arrangement of the magnetic flux concentrator 12 and of the magnetic field sensor 14 or by way of the design of the magnetic circuits and of the associated magnetic fluxes. The arrangement chosen enables the magnetic flux concentrator 12 to align the magnetic field generated as a result of the rotation of the multipole magnet 6 with the magnetic field sensor 14 in such a way that the described opposite imposing of the magnetic stray field on the magnetic fluxes is achieved. In this context, it should be noted that the arrangement of the magnetic flux concentrator 12 and magnetic field sensor 14 shown is by way of example and is not restrictive. In further examples, the magnetic flux concentrator 12 and the magnetic field sensor 14 can also be arranged differently, such that an influence of the magnetic stray field on the sensor signal is compensated for upon coupling of the two magnetic circuits.

FIG. 17 shows an example output signal of the sensor device 1200 under the influence of a magnetic stray field. In this case, the measured magnetic field strength is plotted against the angle of rotation. Since an influence of the magnetic stray field on the sensor signal S1 can be compensated for, the sensor signal S1 can substantially have a profile analogous to FIG. 14.

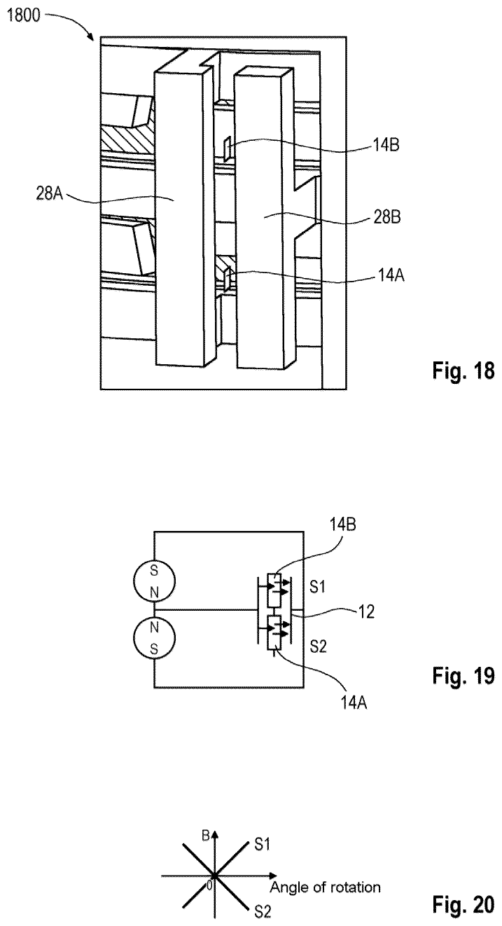

The sensor device 1800 in FIG. 18 can be at least partly similar to the sensor device 1200 in FIGS. 12A-12F and can have identical properties. In contrast to FIGS. 12A-12F, the sensor device 1800 can have two magnetic field sensors 14A and 14B. Each of the magnetic field sensors 14A, 14B can be arranged between the first section 28A and the second section 28B of the magnetic flux concentrator 12. In this case, the magnetic field sensors 14A, 14B can be arranged offset with respect to one another in the z-direction. Furthermore, each of the magnetic field sensors 14A, 14B can be sensitive in a direction perpendicular to the axis of rotation of the multipole magnet 6.

FIG. 19 schematically illustrates, in a simplified illustration, magnetic circuits such as can be formed in the sensor device 1800 from FIG. 18. FIG. 19 can be at least partly similar to FIG. 13. In contrast to FIG. 13, FIG. 19 shows two magnetic field sensors 14A, 14B, at the positions of which the magnetic flux concentrator 12 can concentrate a magnetic field induced upon rotation of the multipole magnet 6. Analogously to FIG. 13, this magnetic field is indicated by small arrows pointing towards the right in FIG. 19.

FIG. 20 shows example output signals S1 and S2 of the magnetic field sensors 14A, 14B of the sensor device 1800 under the influence of a magnetic stray field. Returning to FIG. 16, it has already been explained that the magnetic stray field can be imposed oppositely on the signal contributions of opposite magnetic fluxes in the magnetic circuits. Analogously, in the sensor device 1800, it is possible to compensate for the contribution of the magnetic stray field in each of the sensor signals S1 and S2. The profiles of the signals S1 and S2 can thus be independent of the magnetic stray field.

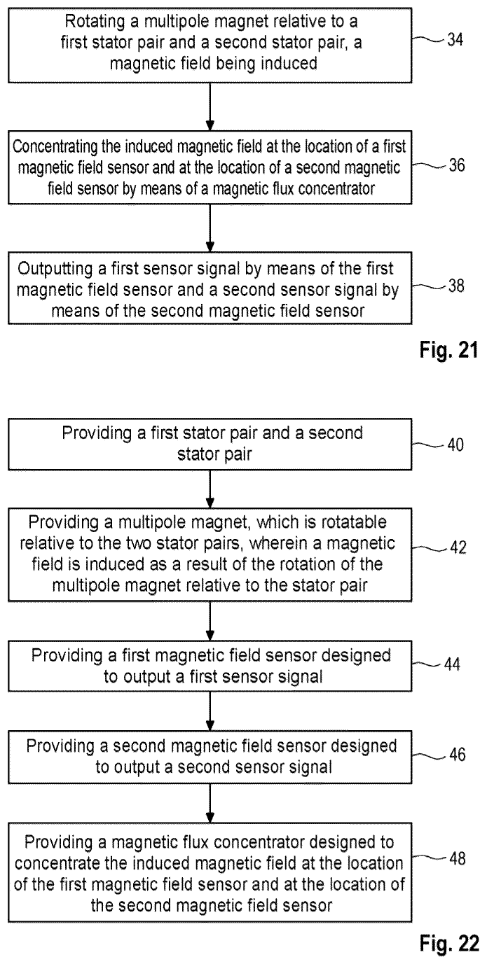

FIG. 21 shows a flow diagram of a method in accordance with the disclosure. The method can be used for example to operate a sensor device in accordance with the disclosure. The method in FIG. 21 can be read in conjunction with each of the preceding figures.

At 34, a multipole magnet can be rotated relative to a first stator pair and a second stator pair, a magnetic field being induced. At 36, the induced magnetic field can be concentrated at the location of a first magnetic field sensor and at the location of a second magnetic field sensor by a magnetic flux concentrator. At 38, a first sensor signal can be output by the first magnetic field sensor and a second sensor signal can be output by the second magnetic field sensor. The magnetic flux concentrator and the two magnetic field sensors are arranged in such a way that an influence of a rotation-independent magnetic stray field on the two sensor signals is compensated for upon difference formation or summation applied to the two sensor signals.

FIG. 22 shows a flow diagram of a method for producing a sensor device in accordance with the disclosure. The method in FIG. 22 can be used for example to manufacture each of the sensor devices in accordance with the disclosure described herein. The method can be read in conjunction with each of the preceding figures.

At 40, a first stator pair and a second stator pair can be provided. At 42, a multipole magnet can be provided, which is rotatable relative to the two stator pairs, wherein a magnetic field is induced as a result of the rotation of the multipole magnet relative to the stator pairs. At 44, a first magnetic field sensor can be provided, which is configured to output a first sensor signal. At 46, a second magnetic field sensor can be provided, which is configured to output a second sensor signal. At 48, a magnetic flux concentrator can be provided, which is configured to concentrate the induced magnetic field at the location of the first magnetic field sensor and at the location of the second magnetic field sensor. The magnetic flux concentrator and the two magnetic field sensors are arranged in such a way that an influence of a rotation-independent magnetic stray field on the two sensor signals is compensated for upon difference formation or summation applied to the two sensor signals.

### Aspects

Sensor devices and also associated production and operating methods are explained below.

Aspect 1 is a sensor device, comprising: a first stator pair, comprising a first ferromagnetic stator and a second ferromagnetic stator; a second stator pair, comprising the second ferromagnetic stator and a third ferromagnetic stator; a multipole magnet, which is rotatable relative to the first stator pair and the second stator pair, wherein a magnetic field is induced as a result of the rotation of the multipole magnet relative to the first stator pair and the second stator pair; a first magnetic field sensor configured to output a first sensor signal; a second magnetic field sensor configured to output a second sensor signal; and a magnetic flux concentrator configured to concentrate the induced magnetic field at a location of the first magnetic field sensor and at a location of the second magnetic field sensor, wherein the magnetic flux concentrator, the first magnetic field sensor, and the second magnetic field sensor are arranged in such a way that an influence of a rotation-independent magnetic stray field on the first sensor signal and the second sensor signal is compensated for upon difference formation or summation applied to the first sensor signal and the second sensor signal.

Aspect 2 is a sensor device according to Aspect 1, wherein the magnetic flux concentrator, the first magnetic field sensor, and the second magnetic field sensor are arranged in such a way that the first sensor signal is inverted with respect to the second sensor signal.

Aspect 3 is a sensor device according to Aspect 1 or 2, wherein: each of the first ferromagnetic stator, the second ferromagnetic stator, and the third ferromagnetic stator is embodied in a ring-shaped fashion and has a multiplicity of teeth, and the first ferromagnetic stator and the second ferromagnetic stator of the first stator pair are arranged oppositely to each other and the teeth of the first and second ferromagnetic stators intermesh and the second ferromagnetic stator and the third ferromagnetic stator of the second stator pair are arranged oppositely to each other and the teeth of the second and third ferromagnetic stators intermesh.

Aspect 4 is a sensor device according to any of the preceding Aspects, wherein the multipole magnet is embodied in a ring-shaped fashion and has a multiplicity of alternating magnetic north poles and magnetic south poles.

Aspect 5 is a sensor device according to Aspect 3 and Aspect 4, wherein in a non-rotated state of the multipole magnet, each tooth of the stators is at an identical distance from a magnetic north pole and a magnetic south pole of the multipole magnet.

Aspect 6 is a sensor device according to any of the preceding Aspects, wherein: the multipole magnet is attached to a first rotary shaft, the first stator pair and the second stator pair are attached to a second rotary shaft, and the first rotary shaft is connected to the second rotary shaft via a torsion bar.

Aspect 7 is a sensor device according to Aspect 6, wherein the sensor device is configured to determine at least one of the following based on the difference formation or summation applied to the two sensor signals: a rotation angle between the first rotary shaft and the second rotary shaft, or a torque applied to the first rotary shaft.

Aspect 8 is a sensor device according to Aspect 6 or Aspect 7, wherein the first rotary shaft is mechanically coupled to a steering column of a vehicle and a rotation of the multipole magnet is based on a rotation of the steering column.

Aspect 9 is a sensor device according to any of the preceding Aspects, wherein the sensor device is configured to be used in an electrical power-assisted steering system.

Aspect 10 is a sensor device according to any of the preceding Aspects, wherein: the magnetic flux concentrator has a first section coupled to the first ferromagnetic stator, a second section coupled to the second ferromagnetic stator, and a third section coupled to the third ferromagnetic stator, each of the first section, the second section, and the third section runs parallel to an axis of rotation of the multipole magnet, the first magnetic field sensor is arranged between the first section and the second section, the second magnetic field sensor is arranged between the second section and the third section, and the first magnetic field sensor and the second magnetic field sensor are each sensitive in a direction perpendicular to the axis of rotation of the multipole magnet.

Aspect 11 is a sensor device according to any of Aspects 1 to 9, wherein: the magnetic flux concentrator has a first section coupled to the first ferromagnetic stator and to the third ferromagnetic stator, and a second section coupled to the second ferromagnetic stator, each of the first section and the second section runs parallel to an axis of rotation of the multipole magnet, the first magnetic field sensor and the second magnetic field sensor are each arranged between the first section and the second section, and the first magnetic field sensor and the second magnetic field sensor are each sensitive in a direction perpendicular to the axis of rotation of the multipole magnet.

Aspect 12 is a sensor device according to any of Aspects 1 to 9, wherein: the magnetic flux concentrator has a first section coupled to the first ferromagnetic stator, a second section coupled to the second ferromagnetic stator, a third section coupled to the second ferromagnetic stator, and a fourth section coupled to the third ferromagnetic stator, each of the first section, the second section, the third section, and the fourth section runs perpendicular to an axis of rotation of the multipole magnet, the first magnetic field sensor is arranged between the first section and the second section, the second magnetic field sensor is arranged between the third section and the fourth section, the first magnetic field sensor and the second magnetic field sensor are each sensitive in a direction parallel to the axis of rotation of the multipole magnet, and a position of the first magnetic field sensor is rotated relative to a position of the second magnetic field sensor about the axis of rotation of the multipole magnet.

Aspect 13 is a sensor device according to any of the preceding Aspects, furthermore comprising: a first electromagnetic shield arranged around the magnetic flux concentrator, the first magnetic field sensor, and the second magnetic field sensor.

Aspect 14 is a sensor device according to any of the preceding Aspects, furthermore comprising: a ring-shaped second electromagnetic shield arranged around the first stator pair, the second stator pair, and the multipole magnet.

Aspect 15 is a sensor device according to any of the preceding Aspects, wherein the first magnetic field sensor and the second magnetic field sensor are each configured to detect an absolute value and a sign of the induced magnetic field in relation to a sensitivity direction.

Aspect 16 is a sensor device according to any of the preceding Aspects, wherein each of the first magnetic field sensor comprises a first Hall sensor and the second magnetic field sensor comprises a second Hall sensor.

Aspect 17 is a sensor device, comprising: a first stator pair, comprising a first ferromagnetic stator and a second ferromagnetic stator; a second stator pair, comprising the second ferromagnetic stator and a third ferromagnetic stator; a multipole magnet, which is rotatable relative to the first stator pair and the second stator pair, wherein a magnetic field is induced as a result of a rotation of the multipole magnet relative to the first stator pair and the second stator pair; a magnetic field sensor configured to output a sensor signal; and a magnetic flux concentrator configured to concentrate the induced magnetic field at a location of the magnetic field sensor, wherein upon rotation of the multipole magnet relative to the first stator pair and the second stator pair, a first magnetic circuit is formed by the magnetic flux concentrator and the first stator pair and a second magnetic circuit is formed by the magnetic flux concentrator and the second stator pair, and wherein the magnetic flux concentrator and the magnetic field sensor are arranged in such a way that an influence of a rotation-independent magnetic stray field on the sensor signal is compensated for upon coupling of the first magnetic circuit and the second magnetic circuit.

Aspect 18 is a sensor device according to Aspect 17, wherein: the magnetic flux concentrator comprises a first section coupled to the first ferromagnetic stator and to the third ferromagnetic stator, and a second section coupled to the second ferromagnetic stator, each of the first section and the second section runs parallel to an axis of rotation of the multipole magnet, the magnetic field sensor is arranged between the first section and the second section, and the magnetic field sensor is sensitive in a direction perpendicular to the axis of rotation of the multipole magnet.

Aspect 19 is a method comprising: rotating a multipole magnet relative to a first stator pair and a second stator pair, wherein a magnetic field is induced; concentrating the induced magnetic field at a location of a first magnetic field sensor and at a location of a second magnetic field sensor using a magnetic flux concentrator; and outputting a first sensor signal using the first magnetic field sensor and a second sensor signal using the second magnetic field sensor, wherein the magnetic flux concentrator, the first magnetic field sensor, and the second magnetic field sensor are arranged in such a way that an influence of a rotation-independent magnetic stray field on the first sensor signal and the second sensor signal is compensated for upon difference formation or summation applied to the first sensor signal and the second sensor signal.

Aspect 20 is a method for producing a sensor device, wherein the method comprises: providing a first stator pair and a second stator pair; providing a multipole magnet, which is rotatable relative to the first stator pair and the second stator pair, wherein a magnetic field is induced as a result of the rotation of the multipole magnet relative to the first stator pair and the second stator pair; providing a first magnetic field sensor configured to output a first sensor signal; providing a second magnetic field sensor configured to output a second sensor signal; and providing a magnetic flux concentrator configured to concentrate the induced magnetic field at a location of the first magnetic field sensor and at a location of the second magnetic field sensor, wherein the magnetic flux concentrator, the first magnetic field sensor, and the second magnetic field sensor are arranged in such a way that an influence of a rotation-independent magnetic stray field on the first sensor signal and the second sensor signal is compensated for upon difference formation or summation applied to the first sensor signal and the second sensor signal.

Although specific implementations have been illustrated and described herein, it is obvious to the person of average skill in the art that a multiplicity of alternative and/or equivalent implementations can replace the specific implementations shown and described, without departing from the scope of the present disclosure. This application is intended to cover all adaptations or variations of the specific implementations discussed herein. Therefore, the intention is for this disclosure to be restricted only by the claims and the equivalents thereof.

What is claimed is:

1. A sensor device, comprising:
a first stator pair comprising a first ferromagnetic stator and a second ferromagnetic stator;
a second stator pair comprising the second ferromagnetic stator and a third ferromagnetic stator;
a multipole magnet, which is rotatable on an axis of rotation relative to the first stator pair and the second stator pair, wherein a magnetic field is induced based on a rotation of the multipole magnet relative to the first stator pair and the second stator pair;
a first magnetic field sensor configured to output a first sensor signal;
a second magnetic field sensor configured to output a second sensor signal; and
a magnetic flux concentrator configured to concentrate the magnetic field at a location of the first magnetic field sensor and at a location of the second magnetic field sensor,
wherein the magnetic flux concentrator comprises a first section coupled to the first ferromagnetic stator, a second section coupled to the second ferromagnetic stator, and a third section coupled to the first ferromagnetic stator,
wherein the first section, the second section, and the third section extend parallel to the axis of rotation of the multipole magnet such that the second section overlaps with the first section and the third section in a circumferential direction, with a first gap formed between the first section and the second section in the circumferential direction and a second gap formed between the second section and the third section in the circumferential direction,
wherein the first magnetic field sensor is arranged in the first gap and the second magnetic field sensor is arranged in the second gap, and
wherein the magnetic flux concentrator, the first magnetic field sensor, and the second magnetic field sensor are arranged in such a way that an influence of a rotation-independent magnetic stray field on the first sensor signal and the second sensor signal is compensated for upon difference formation or summation applied to the first sensor signal and the second sensor signal.

2. The sensor device as claimed in claim 1, wherein the first section, the second section, and the third section are configured to produce concentrated magnetic fields in directions substantially perpendicular to the axis of rotation of the multipole magnet.

3. The sensor device as claimed in claim 2, wherein the first magnetic field sensor and the second magnetic field sensor are each sensitive in a direction substantially perpendicular to the axis of rotation of the multipole magnet.

4. The sensor device as claimed in claim 1, wherein the first section and the third section are arranged co-linear with each other in a direction that is parallel to the axis of rotation of the multipole magnet such that the first section and the third section are located at a same circumferential position about the axis of rotation of the multipole magnet, and wherein a position of the second section is rotated relative to positions of the first section and the third section about the axis of rotation of the multipole magnet such that the third section is located at a different circumferential position than the first section and the third section.

5. The sensor device as claimed in claim 4, wherein the first magnetic field sensor and the second magnetic field sensor are located at substantially a same circumferential position about the axis of rotation of the multipole magnet.

6. The sensor device as claimed in claim 1, wherein the magnetic flux concentrator comprises:
a first circle-arc-shaped section that extends partially around the first ferromagnetic stator and is configured to guide magnetic flux generated based on the rotation of the multipole magnet to the first section,
a second circle-arc-shaped section that extends partially around the second ferromagnetic stator and is configured to guide magnetic flux generated based on the rotation of the multipole magnet to the second section, and
a third circle-arc-shaped section that extends partially around the third ferromagnetic stator and is configured to guide magnetic flux generated based on the rotation of the multipole magnet to the third section.

7. The sensor device as claimed in claim 6, wherein the first section is coupled to the first circle-arc-shaped section and protrudes radially outwardly from the first circle-arc-shaped section,
wherein the second section is coupled to the second circle-arc-shaped section and protrudes radially outwardly from the second circle-arc-shaped section, and
wherein the third section is coupled to the third circle-arc-shaped section and protrudes radially outwardly from the third circle-arc-shaped section.

8. The sensor device as claimed in claim 1, further comprising:
a first electromagnetic shield arranged around the first section, the second section, the third section, the first magnetic field sensor, and the second magnetic field sensor.

9. The sensor device as claimed in claim 1, further comprising:
a ring-shaped second electromagnetic shield arranged circumferentially around the first stator pair, the second stator pair, and the multipole magnet.

10. The sensor device as claimed in claim 1, further comprising:
a first electromagnetic shield arranged around the first section, the second section, the third section, the first magnetic field sensor, and the second magnetic field sensor; and
a ring-shaped second electromagnetic shield arranged circumferentially around the first stator pair, the second stator pair, and the multipole magnet.

11. The sensor device as claimed in claim 1, wherein:
each of the first ferromagnetic stator, the second ferromagnetic stator, and the third ferromagnetic stator is embodied in a ring-shaped fashion and has a multiplicity of teeth, and
the first ferromagnetic stator and the second ferromagnetic stator of the first stator pair are arranged oppositely to each other and the teeth of the first ferromagnetic stator and the teeth of the second ferromagnetic stator intermesh, and the second ferromagnetic stator and the third ferromagnetic stator of the second stator pair are arranged oppositely to each other and the teeth of the second ferromagnetic stator and the teeth of the third ferromagnetic stator intermesh.

12. A sensor device, comprising:
a first stator pair comprising a first ferromagnetic stator and a second ferromagnetic stator;
a second stator pair comprising the second ferromagnetic stator and a third ferromagnetic stator;
a multipole magnet, which is rotatable on an axis of rotation relative to the first stator pair and the second stator pair, wherein a magnetic field is induced based on a rotation of the multipole magnet relative to the first stator pair and the second stator pair;
a first magnetic field sensor configured to output a first sensor signal;
a second magnetic field sensor configured to output a second sensor signal; and
a magnetic flux concentrator configured to concentrate the magnetic field at a location of the first magnetic field sensor and at a location of the second magnetic field sensor,
wherein the magnetic flux concentrator, the first magnetic field sensor, and the second magnetic field sensor are arranged in such a way that an influence of a rotation-independent magnetic stray field on the first sensor signal and the second sensor signal is compensated for upon difference formation or summation applied to the first sensor signal and the second sensor signal,
wherein the magnetic flux concentrator has a first section coupled to the first ferromagnetic stator, a second section coupled to the second ferromagnetic stator, and a third section coupled to the third ferromagnetic stator,
wherein each of the first section, the second section, and the third section runs parallel to the axis of rotation of the multipole magnet,
wherein the first magnetic field sensor is arranged between the first section and the second section,
wherein the second magnetic field sensor is arranged between the second section and the third section, and
wherein the first magnetic field sensor and the second magnetic field sensor are each sensitive in a direction perpendicular to the axis of rotation of the multipole magnet.

13. A sensor device, comprising:
a first stator pair comprising a first ferromagnetic stator and a second ferromagnetic stator;
a second stator pair comprising the second ferromagnetic stator and a third ferromagnetic stator;
a multipole magnet, which is rotatable on an axis of rotation relative to the first stator pair and the second stator pair, wherein a magnetic field is induced based on a rotation of the multipole magnet relative to the first stator pair and the second stator pair;
a first magnetic field sensor configured to output a first sensor signal;
a second magnetic field sensor configured to output a second sensor signal; and
a magnetic flux concentrator configured to concentrate the magnetic field at a location of the first magnetic field sensor and at a location of the second magnetic field sensor,
wherein the magnetic flux concentrator, the first magnetic field sensor, and the second magnetic field sensor are arranged in such a way that an influence of a rotation-independent magnetic stray field on the first sensor signal and the second sensor signal is compensated for upon difference formation or summation applied to the first sensor signal and the second sensor signal,
wherein the magnetic flux concentrator has a first section coupled to the first ferromagnetic stator and to the third ferromagnetic stator, and a second section coupled to the second ferromagnetic stator,
wherein each of the first section and the second section runs parallel to the axis of rotation of the multipole magnet,
wherein the first magnetic field sensor and the second magnetic field sensor are each arranged between the first section and the second section, and
wherein the first magnetic field sensor and the second magnetic field sensor are each sensitive in a direction perpendicular to the axis of rotation of the multipole magnet.

14. The sensor device as claimed in claim 13, wherein the first section and the second section are configured to produce concentrated magnetic fields in directions substantially perpendicular to the axis of rotation of the multipole magnet.

15. The sensor device as claimed in claim 13, wherein a position of the second section is rotated relative to a position of the first section about the axis of rotation of the multipole magnet such that the second section is located at a different circumferential position than the first section.

16. The sensor device as claimed in claim 15, wherein the first magnetic field sensor and the second magnetic field sensor are located at substantially a same circumferential position about the axis of rotation of the multipole magnet.

17. The sensor device as claimed in claim 13, wherein the magnetic flux concentrator comprises:
a first circle-arc-shaped section that extends partially around the first ferromagnetic stator and is configured to guide magnetic flux generated based on the rotation of the multipole magnet to the first section,
a second circle-arc-shaped section that extends partially around the second ferromagnetic stator and is configured to guide magnetic flux generated based on the rotation of the multipole magnet to the second section, and
a third circle-arc-shaped section that extends partially around the third ferromagnetic stator and is configured to guide magnetic flux generated based on the rotation of the multipole magnet to the first section.

18. The sensor device as claimed in claim 17, wherein the first section is coupled to the first circle-arc-shaped section and protrudes radially outwardly from the first circle-arc-shaped section,
wherein the second section is coupled to the second circle-arc-shaped section and protrudes radially outwardly from the second circle-arc-shaped section, and
wherein the first section is coupled to the third circle-arc-shaped section and protrudes radially outwardly from the third circle-arc-shaped section.

19. The sensor device as claimed in claim 13, further comprising:
a first electromagnetic shield arranged around the first section, the second section, the first magnetic field sensor, and the second magnetic field sensor.

20. The sensor device as claimed in claim 13, further comprising:
a ring-shaped second electromagnetic shield arranged circumferentially around the first stator pair, the second stator pair, and the multipole magnet.

21. The sensor device as claimed in claim 13, further comprising:
a first electromagnetic shield arranged around the first section, the second section, the first magnetic field sensor, and the second magnetic field sensor; and
a ring-shaped second electromagnetic shield arranged circumferentially around the first stator pair, the second stator pair, and the multipole magnet.

22. The sensor device as claimed in claim 13, wherein the first section includes a first beam and the second section includes a second beam,
wherein the first beam and the second beam extend parallel to the axis of rotation of the multipole magnet, and
wherein the first beam and the second beam radially overlap with the first ferromagnetic stator, the second ferromagnetic stator, and the third ferromagnetic stator.

23. The sensor device as claimed in claim 22, wherein the first beam and the second beam are located at different circumferential positions about the axis of rotation of the multipole magnet, and
wherein the first magnetic field sensor and the second magnetic field sensor are each arranged circumferentially between the first beam and the second beam.

24. A sensor device, comprising:
a first stator pair comprising a first ferromagnetic stator and a second ferromagnetic stator;
a second stator pair comprising the second ferromagnetic stator and a third ferromagnetic stator;
a multipole magnet, which is rotatable on an axis of rotation relative to the first stator pair and the second stator pair, wherein a magnetic field is induced based on a rotation of the multipole magnet relative to the first stator pair and the second stator pair;
a magnetic field sensor configured to output a sensor signal; and
a magnetic flux concentrator configured to concentrate the magnetic field at a location of the magnetic field sensor,
wherein upon rotation of the multipole magnet relative to the first stator pair and the second stator pair, a first magnetic circuit is formed by the magnetic flux concentrator and the first stator pair and a second magnetic circuit is formed by the magnetic flux concentrator and the second stator pair,
wherein the magnetic flux concentrator and the magnetic field sensor are arranged in such a way that an influence of a rotation-independent magnetic stray field on the sensor signal is compensated for upon coupling of the first magnetic circuit and the second magnetic circuit,
wherein the magnetic flux concentrator comprises a first section coupled to the first ferromagnetic stator and to the third ferromagnetic stator, and a second section coupled to the second ferromagnetic stator,
wherein each of the first section and the second section runs parallel to an axis of rotation of the multipole magnet,
wherein the magnetic field sensor is arranged between the first section and the second section, and
wherein the magnetic field sensor is sensitive in a direction perpendicular to the axis of rotation of the multipole magnet.
